(19) United States
(12) Patent Application Publication
(10) Pub. No.: US 2007/0256007 A1
(43) Pub. Date: Nov. 1, 2007

(54) Methods, systems, and computer program products for managing information by annotating a captured information object

(76) Inventor: James Carlton Bedingfield SR., Lilburn, GA (US)

Correspondence Address: MYERS BIGEL SIBLEY & SAJOVEC, P.A., P.O. BOX 37428, RALEIGH, NC, 27627, US

(21) Appl. No.: 11/411,507

(22) Filed: Apr. 26, 2006

(51) Int. Cl. G06F 17/00; G06F 17/30

(52) U.S. Cl. 715/512; 707/3; 715/531

(57) ABSTRACT

A captured information object is managed by using annotation markers. The information object is annotated with at least one marker. The annotated information object is saved in an electronically searchable file.

### FIELD OF THE INVENTION

The present invention relates generally to information processing and, more particularly, to systems, methods, and computer program products for processing a captured information object.

### BACKGROUND OF THE INVENTION

As days and years go by, people generate exponentially increasing volumes of personal information. Such information can include documents, e-mail messages, photos, videos, music collections, Web page content, medical records, employment records, educational data, etc. This profusion of information can be organized to some degree and presented; however, it may be of limited use due to a lack of efficient data management systems and methods.

Personal data may be acquired from numerous sources through a variety of means. Moreover, the personal data may be stored in various places using various storage means, such as, for example, on a personal computer, on a cell phone, in computer systems or in paper files at a doctor's, lawyers, and/or accountant's office, etc. The personal data may pertain to a single person or may also pertain to one or more people.

Some organizations offer storage services for information, such as, for example, photos and music. Other organizations provide backup services for all electronic information and/or paper files that a person or organization may have. Nevertheless, there remains a need for improvements in collecting and managing personal information.

### SUMMARY OF THE INVENTION

According to some embodiments of the present invention, a captured information object is managed by using annotation markers. The information object is annotated with at least one marker. The annotated information object is saved in an electronically searchable file.

In other embodiments of the present invention, annotating the information object and saving the annotated information object comprises processing the information object to obtain text information therefrom, electronically generating a concordance comprising selected words from the text information, and saving the text information and the concordance in the electronically searchable file.

In still other embodiments of the present invention, annotating the information object and saving the annotated information object comprises displaying the information object via a user interface, adding the least one marker to the information object via the user interface, and saving the information object with the at least one marker in the electronically searchable file.

In still other embodiments of the present invention, the at least one marker comprises an image, a sound, and/or text.

In still other embodiments of the present invention, the at least one marker comprises a date and/or time stamp.

In still other embodiments of the present invention, the information object comprises a graphic object and/or text.

In still other embodiments of the present invention, access to the annotated information object is presented in a visual medium that comprises a path with a plurality of partitions.

In still other embodiments, saving the annotated captured information object in the electronically searchable file comprises saving the at least one marker in the electronically searchable file. The electronically searchable file is separate from a file containing the captured information object, but is associated therewith.

In still other embodiments, the at least one marker is substantially undetectable by manual review.

In still other embodiments, the at least one marker is substantially detectable by manual review.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of exemplary embodiments thereof when read in conjunction with the accompanying drawings, in which:

FIG. 1 is a diagram that illustrates a life history in the graphical chronological path presentation of a highway in accordance with some embodiments of the present invention;

FIG. 2 is a block diagram that illustrates a communication network for managing information by annotating captured information objects in accordance with some embodiments of the present invention;

FIG. 3 illustrates a data processing system that may be used to implement a data processing system of the communication network of FIG. 2 in accordance with some embodiments of the present invention;

FIGS. 4-8 are flowcharts that illustrate operations of managing information by annotating captured information objects in accordance with some embodiments of the present invention; and

FIG. 9 is a user interface for annotating captured information objects in accordance with some embodiments of the present invention.

### DETAILED DESCRIPTION OF EXEMPLARY EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

As used herein, the term “file” may include any construct that binds a conglomeration of information, such as instructions, numbers, words, images, audio, and/or video into a coherent unit. Accordingly, a file may be, for example, a document, an image, an email, a database document, an application, an audio recording, a video recording, and/or a Web page.

Embodiments of the present invention are described herein with respect to managing captured information objects. Captured information objects may be, for example, but not limited to, scanned text or graphic information, electronic text or graphic information captured using a tool, such as a video pen or “cut” tool from a software application, a copy tool/command that is used to make copies of electronic information stored in various media, etc. For example, an individual may wish to maintain a record of various events in his or her life. According to some embodiments of the present invention, such captured information objects may be captured and then annotated to categorize portions of the captured information objects and to facilitate subsequent searching of the audio and/or video record. Moreover, U.S. patent application Ser. No. 11/031,777, entitled “Graphical Chronological Path Presentation,” describes embodiments in which a chronological record of events and information in the life of a person or entity may be displayed or presented by way of a highway representation. U.S. patent application Ser. No. 11/031,777 (hereinafter '777 application) is hereby incorporated herein by reference in its entirety. In some embodiments, the highway is represented as a path with a plurality of partitions. The annotated captured information objects described herein may, for example, be incorporated into one or more of the partitions comprising the path of the '777 application.

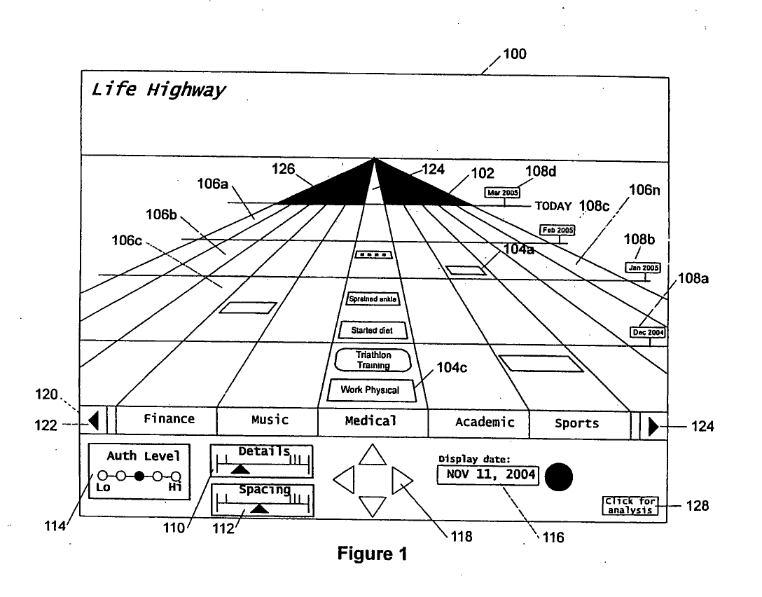

FIG. 1 illustrates a display 100, in accordance with some embodiments of the present invention, that includes a graphical interface of a highway 102 where, for example, nearer entries 104c are earlier in time and farther entries 104a are later in time. In other embodiments, this can be reversed or factors other than time can be used, such as importance and/or priority. Multiple lanes can be used to categorize events (a single lane could be used if desired). Lanes may optionally show, for example, a person's age and/or the calendar year as mile markers 108a-d extending across the lanes, with optional displays by month, week, etc.

In some embodiments, the user reviews the events by “flying over” or “driving down” the highway 102. Control can be provided using directional arrows 118 or, in other embodiments, keyboard arrows, keyboard mnemonics, a mouse, a joystick, a trackball, and/or a touchscreen. A user can also enter text data for searches or for navigation to a specific year or age. The user can pick a lane 106a-106n on the highway to drive in. The lane 124 that the viewer (“driver”) is in may be signified by a representation of headlights and the driver may see details of the events in that lane; but the driver may also see events in other lanes and can move into other lanes at will. Certain lanes and/or events may be concealed from a given viewer or class of viewers. A class of viewers may correspond to an authorization level.

The category bar 120 holds the label for the category of the events in a lane. If there are more lanes than the settings afford to fit on the screen, the user/viewer can scroll to either side, if available, with arrows 122, 124. The user can set the level of detail for each event with the sliding bar 110. The user can set a maximum detail for an event for an authentication level settable in authentication window 114. A viewer can see the authentication level in the authentication window 114, but cannot change it. A viewer may change the detail level up to the maximum level set by the user and may set the spacing to any desired level in the spacing window 112. The settings in each window 110, 112, and 114 may be performed with sliding bars, radio buttons, or other generally known methods.

The display date window displays the current date when entering the highway. However, the date in the display date window 116 may change to the date of the event that a user/viewer hovers over or selects, configurable by the user/viewer.

Other embodiments may include a feature for developing an indication that some event has been viewed. A trail is kept of the events that are viewed. The indication gets stronger as the event is viewed more often. As time passes, if the event is not viewed, the strength of the indication dissipates. The indication may be used to cache certain events with strong indications for quicker access.

Embodiments of the highway 102 is described in more detail in the '777 application, which has been incorporated by reference as discussed above.

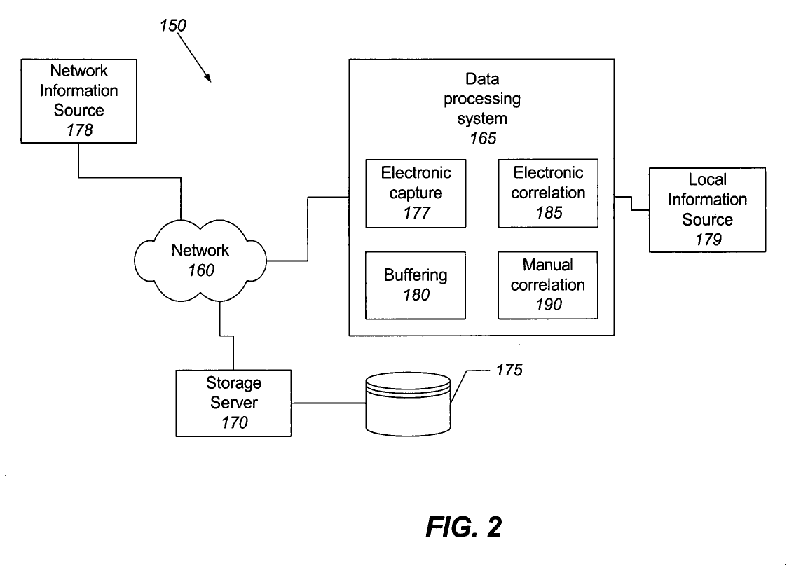

Referring now to FIG. 2, an exemplary network architecture 150 for managing information by annotating captured information objects, in accordance with some embodiments of the invention, comprises a network 160, a data processing system 165, a storage server 170, a network information source, and a local information source. The network 160 may be a global network, such as the Internet, public switched telephone network (PSTN), or other publicly accessible network. Various elements of the network may be interconnected by a wide area network, a local area network, an Intranet, and/or other private network, which may not accessible by the general public. Thus, the network 160 may represent a combination of public and private networks or a virtual private network (VPN). The storage server 170 may optionally be used to store the processed audio and/or video information in repository 175 for access by one or more users.

The data processing system 165 may be configured to provide various functionality, in accordance with some embodiments of the present invention, including, but not limited to, an electronic capture function 177, a buffering function 180, an electronic correlation function 185, and a manual correlation function 190. The electronic capture function 177 may represent various tools and/or applications, such as scanners and/or video pens, applications, and the like that may be used to capture information from the local information source 179 and/or the network information source 178. The local information source 179 and the network information source 178 may represent any sources that may contain one or more information objects, such as text, graphics, video, and the like. The captured file may be referred to as a captured information object as the file may include graphics, text, video, or other information formats in accordance with various embodiments of the present invention.

The information captured by the electronic capture function may be buffered in the capture device(s) and/or may be buffered in the data processing system 165. Once an information capture session is complete, the user may elect to save the captured information from the buffer to a more permanent storage location or may elect to simply discard the captured information if the user so desires. If the captured information is saved, then the user may elect to overwrite old captured information with the newly captured information or, in other embodiments, may elect to archive the old captured information and add the newly captured information to more permanent storage. When saving the newly captured information, the user may also elect to add a privacy safeguard to the information to prevent others from reviewing the information if the information is stored in a location that may be accessed by others, for example.

The captured information may be processed so as to add markers thereto that may facilitate searching of the information by the user or others. In this regard, the data processing system 165 may include an electronic correlation function 185 that may be used to electronically process a captured file and insert markers therein that are correlated with passages or segments of the file. In the case of a graphics file, the electronic correlation function 185 may provide a text extraction function that generates a text file based on the captured graphics file. The text file may then be processed to generate a concordance of words therein. The words that are deemed relevant may then be correlated with passages in the text file to allow a user to search for keywords and then call up passages of the text that are correlated with those keywords. In the case of a video file, the electronic correlation function 185 may detect logical divisions in the video information and insert markers in the video file identifying these transition points.

Instead of or in addition to an electronic correlation function 185, the data processing system 190 may include a manual correlation function 190 that may provide a user with an interactive technique for annotating a captured file with markers. The manual correlation function 190 may provide a user interface for a user to review a captured file and to insert keywords, sounds, images, or other type of marker to facilitate searching of the captured file.

In some embodiments, the electronic correlation function 185 and the manual correlation function 190 may be used to generate a single annotated captured information object file. In these embodiments, the single file contains both the subject matter content along with the markers inserted to annotate the file to facilitate searching. In other embodiments, the electronic correlation function and the manual correlation function 190 may be used to generate a separate annotation file that is associated with the captured information object file. In these embodiments, the captured information object file remains unchanged and the annotation file contains the markers that may be implemented using records. Each record may include an annotation and an associated location in the original captured information object file. For example, one annotation could be “dinner conversation with Ben about regatta results,” and the location could be in the form HH:NM:SS (relative time from start) or YYYY/MM/DD HH:MM:SS (absolute date and time) for an audio file. Similar date/time location and/or a frame counter could be used for a video file. The separate annotation file may be especially useful, for example, when the captured information object file is stored on a read-only medium (e.g., CD or DVD) and/or when it is undesirable to alter the original file.

The electronic capture function 177, buffering function 180, electronic correlation function 185, and manual correlation function 190 will be discussed in greater detail below. Although FIG. 2 illustrates an exemplary communication network, it will be understood that the present invention is not limited to such configurations, but is intended to encompass any configuration capable of carrying out the operations described herein.

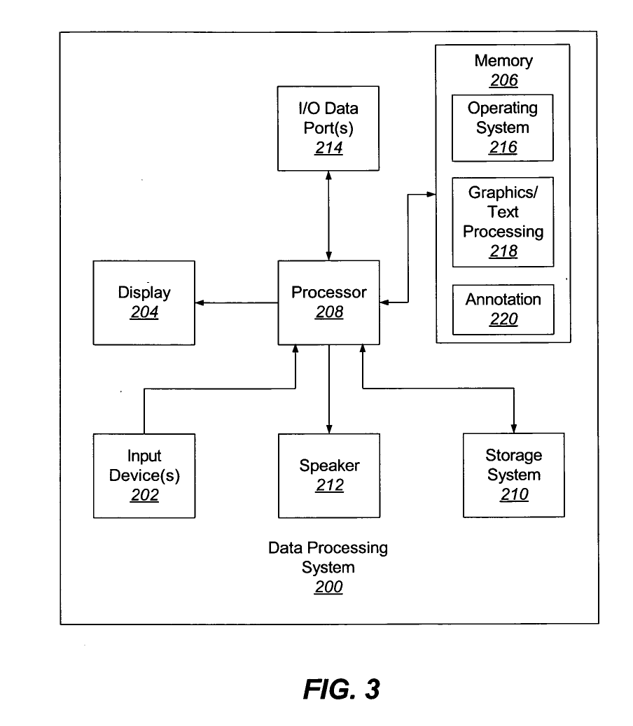

Referring now to FIG. 3, a data processing system 200 that may be used to implement the data processing system 165 of FIG. 2, in accordance with some embodiments of the present invention, comprises input device(s) 202, such as a keyboard or keypad, a display 204, and a memory 206 that communicate with a processor 208. The data processing system 200 may further include a storage system 210, a speaker 212, and an input/output (I/O) data port(s) 214 that also communicate with the processor 208. The storage system 210 may include removable and/or fixed media, such as floppy disks, ZIP drives, hard disks, or the like, as well as virtual storage, such as a RAMDISK. The I/O data port(s) 214 may be used to transfer information between the data processing system 200 and another computer system or a network (e.g., the Internet). These components may be conventional components such as those used in many conventional computing devices, which may be configured to operate as described herein.

The processor 208 communicates with the memory 206 via an address/data bus. The processor 208 may be, for example, a commercially available or custom microprocessor. The memory 206 is representative of the one or more memory devices containing the software and data used for managing captured information objects in accordance with some embodiments of the present invention. The memory 206 may include, but is not limited to, the following types of devices: cache, ROM, PROM, EPROM, EEPROM, flash, SRAM, and DRAM.

As shown in FIG. 3, the memory 206 may contain up to three or more categories of software and/or data: an operating system 216, a graphics/text processing module 218, and an annotation module 220. The operating system 216 generally controls the operation of the data processing system 200. In particular, the operating system 216 may manage the data processing system's software and/or hardware resources and may coordinate execution of programs by the processor 208. The graphics/text-processing module 218 may be configured to process a captured information object by, for example, using text recognition technology to obtain text information from a graphics object file. The graphics/text-processing module 218 may also manage captured information object files by saving those files that a user desires to maintain and deleting or overwriting those files that a user wishes to discard. The annotation module 220 may be configured to process captured information object files by annotating the captured information object files with one or more markers. Such markers may allow a user to categorize or highlight various portions of an information object file. Advantageously, this may allow a user to search more quickly for desired segments of an information object file using the one or more markers as search term(s). In accordance with various embodiments of the present invention described in more detail below, the annotation module 220 may provide for automatic, electronic annotation of a captured information object file as discussed above with respect to the electronic correlation function 185 of FIG. 2 or may provide for a manual annotation of a captured information object file in which one or more markers are obtained from a user through, for example, a user interface as discussed above with respect to the manual correlation function 190 of FIG. 2.

Although FIG. 3 illustrates exemplary hardware/software architectures that may be used in data processing systems, such as the data processing system 165 of FIG. 2, for managing captured information object files, it will be understood that the present invention is not limited to such a configuration but is intended to encompass any configuration capable of carrying out operations described herein. Moreover, the functionality of the data processing system 165 of FIG. 2 and the data processing system 200 of FIG. 3 may be implemented as a single processor system, a multi-processor system, or even a network of stand-alone computer systems, in accordance with various embodiments of the present invention.

Computer program code for carrying out operations of data processing systems discussed above with respect to FIGS. 2 and 3 may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

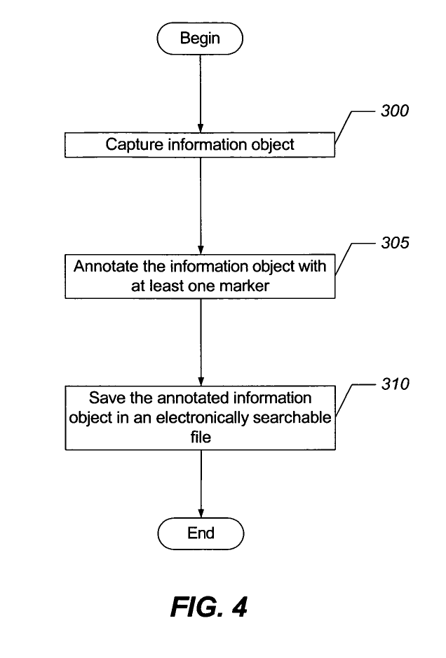

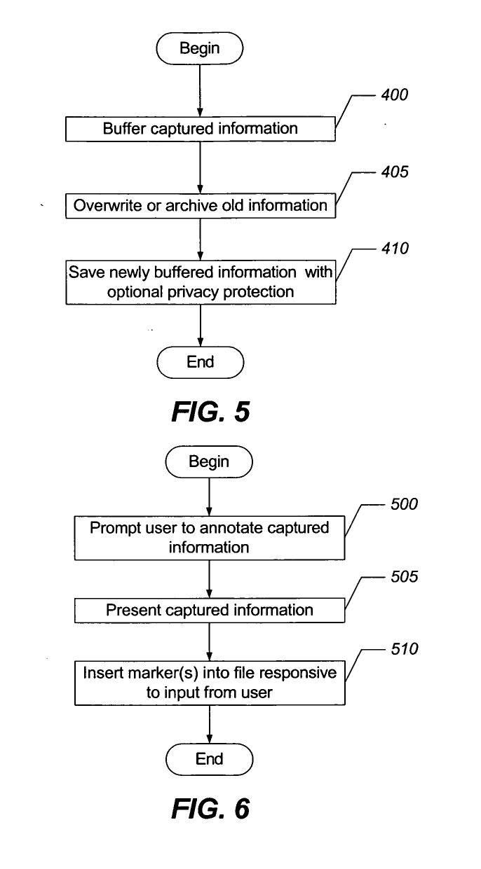

Exemplary operations for managing information by annotating captured information objects will now be described with reference to FIGS. 4 and 2. Operations begin at block 300 where the electronic capture function 177 captures one or more information object files. As discussed above, a captured information object may be, but is not limited to, scanned text or graphic information, electronic text or graphic information captured using a tool, such as a video pen or “cut” tool from a software application, a copy tool/command that is used to make copies of electronic information stored in various media, etc. For example, a user may wish to scan newspaper clippings related to an important event in his or her life. Another user may wish to scan portions of a book that is particularly meaningful to him or her. Some users may wish to retain portions of a Website or a document published on the Internet. These examples are provided for purposes of illustration as embodiments of the present invention are not limited to these specific examples. Referring now to FIG. 5, the captured information object file(s) may be buffered either in the capturing device and/or the buffering function 180 of a data processing system at block 400. The buffered information object may be transferred to the data processing system 200 where the graphics/text processing module 218 may save or discard the buffered information object file(s) based on input received from a user. As indicated at block 405, the new buffered information object file(s) may overwrite old information that has been saved or the old information object file(s) may be archived and the newly buffered information saved without overwriting any old information object file(s). In some embodiments, the newly buffered information may be saved with privacy protection at block 410. This may be useful if the information object file(s) are stored in a public storage location or in a location that others may have access or gain access to.

Returning to FIG. 4, at block 305, the information object file(s) are annotated with one or more markers. As discussed above, the marker(s) may serve to categorize and/or highlight segments of the audio, video, text, and/or graphic information, which may facilitate searching of the information object by one or more users. In some embodiments, the captured information object file(s) may be annotated after they have been captured. For example, referring now to FIG. 6, as annotation may be more effective if done within a relatively short time that an information object has been captured, the graphics/text processing module 218 may prompt a user to annotate captured information object(s) that have been provided by the electronic capture function 177 at block 500. In some embodiments of the present invention, the graphics/text processing module 218 may present the captured information object at block 505 to allow the annotation module 220 to insert one or more markers into the captured information object responsive to input from a user at block 510. The information object may be presented using various techniques depending on the media type of the information object. For example, the information object may be played as a video, displayed as a text file or slide show, displayed as a graphics file, or even played as an audio file as text-to-speech recognition may be used to convert a text object to an audio file. The marker(s) may be, for example, an audio marker, such as a sound, keyword, or the like in the case of an recorded audio file and may be an audio, graphic, and/or video marker in the case of a recorded video file. The marker(s) may also be a keyword, graphic, or the like in the case of a text and/or graphics file.

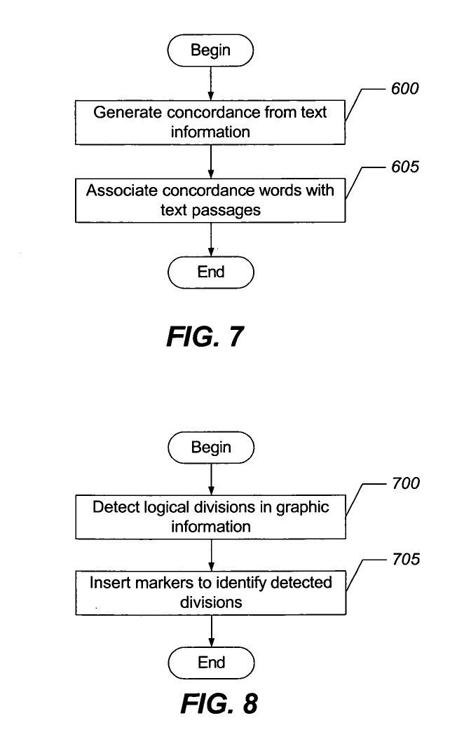

As discussed above, the annotation module 220 may provide for electronic generation of one or more markers to annotate a captured information object file without the need for user input. For example, referring now to FIG. 7, the annotation module 220 may use text extraction technology to obtain text information from a graphics file, for example. Similarly, audio obtained as part of a video capture may be processed using speech-to-text recognition technology to obtain text therefrom. The annotation module 220 may generate a concordance comprising selected words from the text information at block 600 and the text information and concordance may be saved together in an electronically searchable format such that passages of the text information are associated with the words in the concordance at block 605. Various tools may be used to convert the annotated text back into original graphic and/or video format if desired.

Similarly, referring now to FIG. 8, the annotation module 220 may process graphic and/or video information to detect logical divisions therein, such as, for example, when a scene or image changes at block 700. The annotation module 220 may generate one or more, text, audio, video, and/or graphic markers to identify the logical divisions in the graphic and/or video information and the markers may be saved together with the graphic and/or video information in an electronically searchable format at block 705.

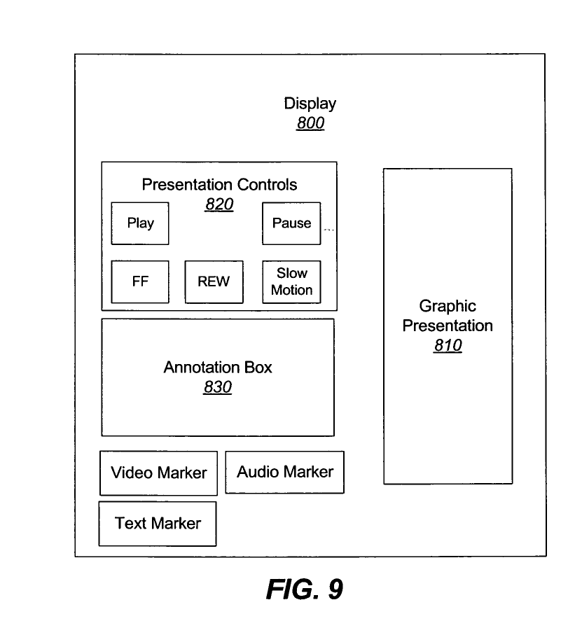

To facilitate annotation of captured information object files, the annotation module 220 may provide a user interface as shown in FIG. 9 in which a display 800 includes a window 810 in which the graphic, text, audio, and/or video information may be presented to a user. A user may manipulate the presentation controls 820 to pause, speed up, slow down, etc. the presentation to allow the user to enter custom markers in the annotation box 830, which are then added to the graphic, video, text, and/or audio information. The custom markers may include, but are not limited to, typed text, uploaded images, sounds input through a microphone, and the like. Icons may also be provided, for example, to allow the user to input standard video/graphic markers, text markers, and/or audio markers into captured information object file. This may be useful when a user simply wants to partition a captured information object file into segments without the need to distinguish between markers or to add additional information by way of the marker.

In accordance with various embodiments of the present invention, the markers used to annotate the captured information object file may be constructed to be of value during a human search and/or during a mechanical search (i.e., automated search). For example, one type of marker that may be used for a video file is a visible icon or image that appears on multiple video frames and is visible during a fast-forward operation. Similarly, for an audio file, an audio marker may be used that is audible and understandable when the audio file is played in a fast-forward manner. To facilitate a mechanical/automated search, embedded markers may be used that are virtually undetectable during a manual review. For example, a marker may be a short burst of high-frequency audio that encodes the annotation and/or a digital annotation embedded in the first few pixels of the first line of a video image. It will be understood that captured information object files may include markers of both types that are of value during both human searching and mechanical searching for increased flexibility in accordance with various embodiments of the present invention.

Returning to FIG. 4, the annotated captured information object is saved as an electronically searchable file at block 310. The file may advantageously be searched based on the one or more markers contained therein, such as image, sound, text, date, and video markers and the like. Such captured information objects may, for example, be used to record various events for an entity, a person, the person's family, or others. In some embodiments, a user may also wish to assign the annotated captured information object file(s) to one or more of the partitions comprising the highway 102 of FIG. 1. The highway 102 may thus serve as a metaphor for the user's life allowing relatively rapid access of information that may be categorized, for example, by subject matter and/or time as illustrated in FIG. 1. Moreover, the annotation functionality provided by some embodiments of the present invention may allow a user to more readily search captured information that has been saved as part of the highway 102.

The flowcharts of FIGS. 4-8 illustrate the architecture, functionality, and operations of some embodiments of methods, systems, and computer program products for managing information by annotating captured information objects. In this regard, each block represents a module, segment, or portion of code, which comprises one or more executable instructions for implementing the specified logical function(s). It should also be noted that in other implementations, the function(s) noted in the blocks may occur out of the order noted in FIGS. 4-8. For example, two blocks shown in succession may, in fact, be executed substantially concurrently or the blocks may sometimes be executed in the reverse order, depending on the functionality desired.

Many variations and modifications can be made to the embodiments described herein without substantially departing from the principles of the present invention. All such variations and modifications are intended to be included herein within the scope of the present invention, as set forth in the following claims.

That which is claimed:

1. A method of managing information, comprising:
capturing an information object;
annotating the information object with at least one marker; and
saving the annotated information object in an electronically searchable file.

2. The method of claim 1, wherein annotating the information object and saving the annotated information object comprises:
processing the information object to obtain text information therefrom;
electronically generating a concordance comprising selected words from the text information; and
saving the text information and the concordance in the electronically searchable file.

3. The method of claim 1, wherein annotating the information object and saving the annotated information object comprises:
displaying the information object via a user interface;
adding the least one marker to the information object via the user interface; and
saving the information object with the at least one marker in the electronically searchable file.

4. The method of claim 1, wherein the at least one marker comprises an image, a sound, and/or text.

5. The method of claim 1, wherein the at least one marker comprises a date and/or time stamp.

6. The method of claim 1, wherein the information object comprises a graphic object and/or text.

7. The method of claim 1, further comprising:
presenting access to the annotated information object in a visual medium that comprises a path with a plurality of partitions.

8. The method of claim 1, wherein saving the annotated information object in the electronically searchable file comprises:
saving the at least one marker in the electronically searchable file;
wherein the electronically searchable file is separate from a file containing the captured information object, but is associated therewith.

9. The method of claim 1, wherein the at least one marker is substantially undetectable by manual review.

10. The method of claim 1, wherein the at least one marker is substantially detectable by manual review.

11. A system for managing information, comprising:
a capture module that is configured to capture an information object; and
a processor that is configured to annotate the information object with at least one marker, and to save the annotated information object in an electronically searchable file.

12. The system of claim 11, wherein the processor is further configured to process the information object to obtain text information therefrom, to electronically generate a concordance comprising selected words from the text information, and to save the text information and the concordance in the electronically searchable file.

13. The system of claim 11, wherein the processor is further configured to display the information object via a user interface, to add the least one marker to the information object via the user interface, and to save the information object with the at least one marker in the electronically searchable file.

14. The system of claim 11, wherein the at least one marker comprises an image, a sound, and/or text.

15. The system of claim 11, wherein the at least one marker comprises a date and/or time stamp.

16. The system of claim 11, wherein the information object comprises a graphic object and/or text.

17. The system of claim 11, wherein the processor is further configured to present access to the annotated information object in a visual medium that comprises a path with a plurality of partitions.

18. A computer program product for managing information, comprising:
a computer readable storage medium having computer readable program code embodied therein, the computer readable program code comprising:
computer readable program code configured to capture an information object;
computer readable program code configured to annotate the information object with at least one marker; and
computer readable program code configured to save the annotated information object in an electronically searchable file.

19. The computer program product of claim 18, wherein the computer readable program code configured to annotate the information object and save the annotated information object comprises:
computer readable program code configured to process the information object to obtain text information therefrom;
computer readable program code configured to electronically generate a concordance comprising selected words from the text information; and
computer readable program code configured to save the text information and the concordance in the electronically searchable file.

20. The computer program product of claim 18, wherein the computer readable program code configured to annotate the information object and save the annotated information object comprises:
computer readable program code configured to display the information object via a user interface;
computer readable program code configured to add the least one marker to the information object via the user interface; and
computer readable program code configured to save the information object with the at least one marker in the electronically searchable file.
